(19) United States
(12) Patent Application Publication
(10) Pub. No.: US 2002/0145784 A1
(43) Pub. Date: Oct. 10, 2002

(54) Optical wavelength switching system with wavelength selective splitters and combiners

(76) Inventors: Zhensheng Zhang, San Diego, CA (US); De Yu Zang, Irvine, CA (US); Xinhong Wang, San Diego, CA (US)

Correspondence Address: BROBECK, PHLEGER & HARRISON LLP, 12390 EL CAMINO REAL, SAN DIEGO, CA, 92130, US

(21) Appl. No.: 09/828,328

(22) Filed: Apr. 5, 2001

(51) Int. Cl. G02B 6/26; G02B 6/42; H04J 14/02

(52) U.S. Cl. 359/128; 385/16

(57) ABSTRACT

An optical wavelength switching system utilizes wavelength selective splitters and combiners arranged in one or more stages to select one or more wavelengths for optical switching. In an embodiment, the splitters and the combiners comprise tunable optical filters which are capable of being tuned to selected wavelengths for optical switching in a dense wavelength division multiplexing (DWDM) network.

### BACKGROUND OF THE INVENTION

1. Field of the Invention

The present invention relates to switching systems, and more particularly, to optical wavelength switching systems.

2. Background

Optical wavelength switching systems with wavelength multiplexers and demultiplexers have been used in optical fiber networks including wavelength division multiplexing (WDM) networks and dense wavelength division multiplexing (DWDM) networks to switch optical signals between different physical optical paths at multiple wavelengths. A typical example of a conventional optical wavelength switching system is shown in FIG. 1, in which a plurality of wavelength demultiplexers 108a, 108b, 108c and 108d, a plurality of wavelength multiplexers 110a, 110b, 110c and 110d, and a plurality of optical switches 112a, 112b, . . . 112m are provided to switch optical signals between different input and output optical fibers for each of the wavelengths carried by the wavelength-multiplexed light beams.

In the example shown in FIG. 1, four input optical fibers 102a, 102b, 102c and 102d each carrying wavelength-multiplexed input optical signals are connected to the wavelength demultiplexers 108a, 108b, 108c and 108d, respectively, to demultiplex the input optical signals into a plurality of single-wavelength optical signals. Each of the demultiplexers has a number of output optical ports no less than the number of wavelengths carried by the wavelength-multiplexed input light beam in each input optical fiber.

In the example shown in FIG. 1, a plurality of m optical switches 112a, 112b, . . . 112m are connected to the output ports of the wavelength demultiplexers if each wavelength-multiplexed input light beam carries optical signals at up to m wavelengths. For example, the first optical switch 112a is connected to the demultiplexer output ports 114a, 116a, 118a and 120a to switch the optical signals at a first wavelength λ₁, while the second optical switch 112b is connected to the demultiplexer output ports 114b, 116b, 118b and 120b to switch the optical signals at a second wavelength λ₂. In this example, each of the optical switches 112a, 112b, . . . 112m comprises a 4×4 optical switch matrix. Such a structure allows optical signals of the same wavelength to be switched between different input and output optical fibers. The multiplexers 110a, 110b, 110c and 110d are connected to the optical switches to multiplex the switched single-wavelength optical signals together to form new wavelength-multiplexed signals, which are transmitted along output optical fibers 104a, 104b, 104c and 104d.

In a conventional optical wavelength switching system, a plurality of wavelength demultiplexers are implemented to demultiplex wavelength-division-multiplexed input optical signals from the input optical fibers into single-wavelength signals each carried by a separate optical fiber for optical switching operations, while a plurality of wavelength multiplexers are implemented to multiplex switched single-wavelength optical signals together to form wavelength-multiplexed output signals. In a typical modern optical fiber communications network, each of the input or output optical fibers connected to the input or output of an optical wavelength switching system may carry sixteen, thirty-two, forty or even eighty wavelength channels. In a conventional optical wavelength switching system such as the one shown in FIG. 1, the wavelength demultiplexers and multiplexers are required to demultiplex and multiplex all of the wavelengths carried by the optical fibers.

In a typical optical fiber communications network, for example, an optical ring network, it is not an unusual situation that only one wavelength or a few of the wavelengths need be switched among different optical fibers at a given time. Even if only a few wavelengths, for example, two or three wavelengths, need be switched among different optical fibers in a DWDM network which utilizes a large number of wavelength channels, for example, forty or eighty channels, all of the wavelengths in each optical fiber need be demultiplexed, transmitted through the optical switches, and then multiplexed to form output optical signals to be carried along output optical fibers. Optical wavelength multiplexers and demultiplexers, especially those used for multiplexing and demultiplexing large numbers of optical wavelengths in DWDM applications, are usually very expensive devices.

Furthermore, in a conventional optical wavelength switching system, a large number of optical switches equal to the total number of wavelengths carried by the input optical fibers are required for all of the wavelengths even though only a few of the wavelengths may need to be switched at a given time. On the other hand, if only a few optical switches less than the total number of wavelengths carried by the optical fibers are implemented in a conventional optical wavelength switching system with wavelength multiplexers and demultiplexers, then only those few fixed wavelengths can be switched by the optical switches, thereby resulting in a severe lack of flexibility.

Therefore, it is desirable to implement in a DWDM network a relatively inexpensive optical wavelength switching system which obviates the need for expensive optical wavelength multiplexers and demultiplexers for multiplexing and demultiplexing a large number of optical wavelengths, and which is suitable for applications in which only a small number of wavelengths need be selected from the large number of wavelengths utilized by the DWDM network and switched among different optical fibers at a given time.

### SUMMARY OF THE INVENTION

The present invention provides an optical wavelength switching system, general comprising:

a plurality of optical inputs each capable of receiving optical signals in a plurality of optical wavelength channels;

a plurality of splitters comprising a plurality of first-stage splitters connected to the optical inputs, the first-stage splitters each having a band-pass output to transmit optical signals in a first wavelength channel and a band-reject output to transmit optical signals in at least one remaining wavelength channel;

a plurality of optical outputs each capable of transmitting wavelength-multiplexed optical signals;

a plurality of combiners comprising a plurality of first-stage combiners connected to the optical outputs, the first-stage combiners each having a first input to receive optical signals in the first wavelength channel and a second input to receive optical signals in said at least one remaining wavelength channel; and

at least one optical switch connected between at least of one of the splitters and at least one of the combiners to switch optical signals in at least one of the wavelength channels.

In an embodiment, a plurality of second-stage splitters and second-stage combiners are connected to the first-stage splitters and first-stage combiners, respectively, to allow optical switching operations to be achieved for a second wavelength channel. In a further embodiment, third-stage splitters and third-stage combiners or additional stages of splitters and combiners may be implemented to allow optical switching operations to be achieved for a third wavelength channel or additional wavelength channels carried by optical fibers connected to the inputs of the system.

In an embodiment, the splitters and combiners comprise tunable wavelength channel splitters and combiners, respectively, for wavelength tuning of optical signals to desired wavelengths for switching operations by the optical switches, thereby allowing any of the wavelengths carried by the optical fibers in a DWDM network to be selected and filtered for optical switching. In an embodiment, the optical wavelength switching system according to the present invention obviates the need for expensive wavelength multiplexers and demultiplexers for multiplexing and demultiplexing a large number of optical wavelengths in a typical DWDM network.

### BRIEF DESCRIPTION OF THE DRAWINGS

The present invention will be described with particular embodiments thereof, and references will be made to the drawings in which:

FIG. 1, described above, shows an example of a conventional optical wavelength switching system with a plurality of optical wavelength multiplexers and demultiplexers;

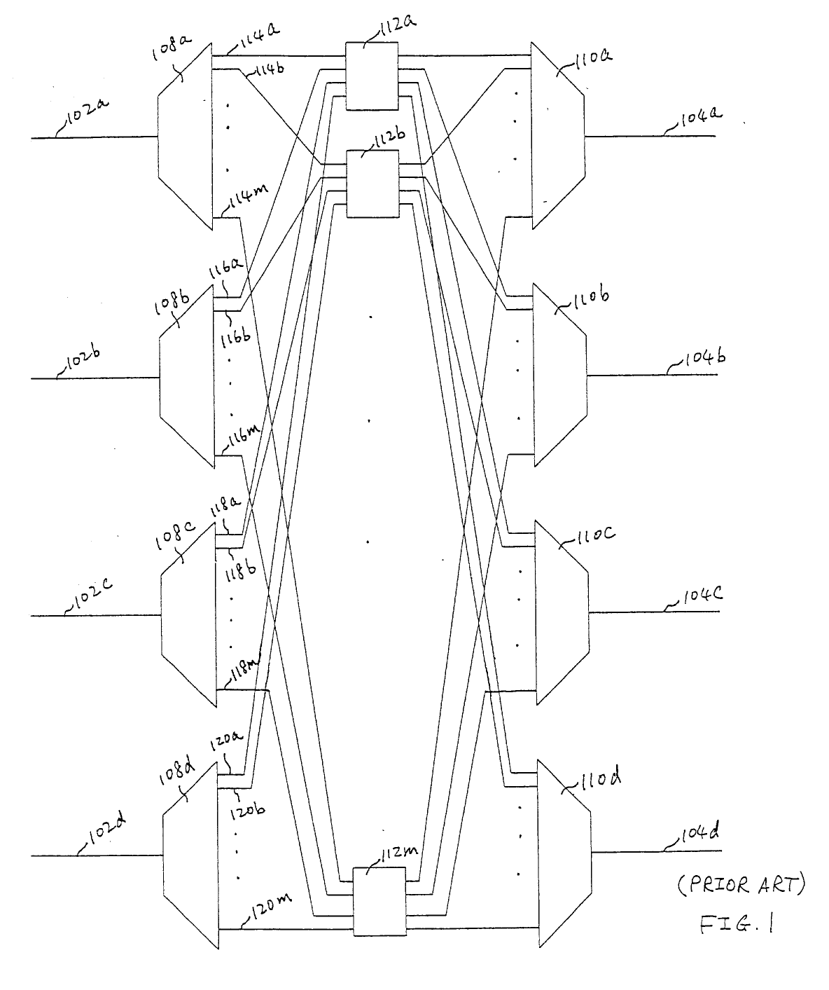

FIG. 2 shows an embodiment of an optical wavelength switching system according to the present invention, with two stages of tunable wavelength channel splitters and combiners and two optical switches for optical switching of up to two wavelength channels; and

FIG. 3 shows another embodiment of the optical wavelength switching system according to the present invention, with three stages of tunable wavelength channel splitters and combiners and four optical switches for optical switching operations.

### DETAILED DESCRIPTION

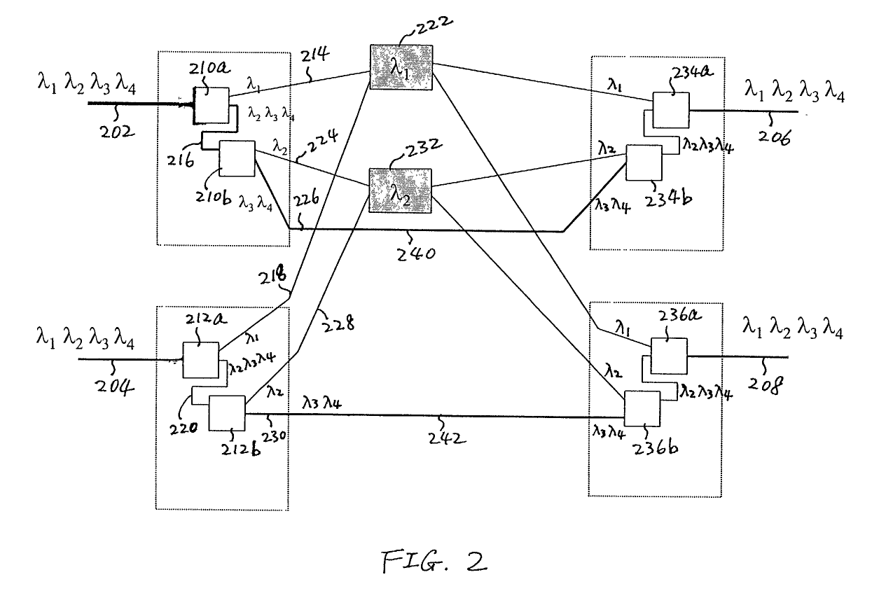

FIG. 2 shows an embodiment of an optical wavelength switching system having two optical switches for switching two single-wavelength channels between different input and output optical fibers. In the embodiment shown in FIG. 2, two input optical fibers 202 and 204 and two output optical fibers 206 and 208 are connected to the optical wavelength switching system. Each of the input and output optical fibers 202, 204, 206 and 208 is capable of carrying wavelength-multiplexed optical signals in a plurality of wavelength channels. The optical wavelength switching system according to the present invention is applicable to wavelength division multiplexing (WDM) or dense wavelength division multiplexing (DWDM) networks which require optical switching of one or more wavelength channels. In a typical DWDM optical network, for example, predetermined wavelengths may be assigned to the individual wavelength channels in accordance with the standard International Telecommunication Union (ITU) spectral grid. The optical wavelength switching system may also be implemented in other types of optical communications networks for the optical switching of broadband or narrowband wavelength channels.

For the purpose of simplifying the illustration in FIG. 2, each of the input and output optical fibers 202, 204, 206 and 208 is shown as carrying four wavelength-multiplexed optical channels at wavelengths λ₁, λ₂, λ₃ and λ₄, although each of the input and output optical fibers may be assigned to carry wavelength-multiplexed optical signals at a much greater number of wavelengths, for example, sixteen, thirty-two, forty or even eighty wavelengths. In the input portion of the optical wavelength switching system, a plurality of wavelength selective splitters 210a, 210b, 212a and 212b are connected to the input optical fibers 202 and 204 to split optical signals at wavelengths λ₁ and λ₂ from the wavelength-multiplexed input optical signals. As shown in FIG. 2, two first-stage splitters 210a and 212a have inputs connected to the input optical fibers 202 and 204, respectively.

The first-stage splitter 210a, which is connected to the first input optical fiber 202, has a band-pass output 214 for transmitting optical signals in the first wavelength channel at wavelength λ₁ and a band-reject output 216 for transmitting optical signals in the remaining wavelength channels at wavelengths λ₂, λ₃ and λ₄. In a similar manner, the other first-stage splitter 212a, which is connected to the second input optical fiber 204, has a band-pass output 218 for transmitting optical signals in the first wavelength channel at wavelength λ₁ and a band-reject output 220 for transmitting optical signals in the remaining wavelength channels at wavelengths λ₂, λ₃ and λ₄. The band-pass outputs 214 and 218 from the first-stage splitters 210a and 212a are connected to the inputs of a first optical switch 222, which is assigned to perform optical switching operations for optical signals at wavelength λ₁.

The second-stage splitter 210b has an input connected to the band-reject output 216 of the first-stage splitter 210a, a band-pass output 224 for transmitting optical signals in a second wavelength channel at wavelength λ₂ and a band-reject output 226 for transmitting optical signals in the remaining wavelength channels at wavelengths λ₃ and λ₄. In a similar manner, the second-stage splitter 212b has an input connected to the band-reject output 220 of the first-stage splitter 212a to receive optical signals at wavelengths λ₂, λ₃ and λ₄, a band-pass output 228 for transmitting optical signals at wavelength λ₂, and a band-reject output 230 for transmitting optical signals in the remaining wavelength channels at wavelengths λ₃and λ₄. The band-pass outputs 224 and 228 of the second-stage splitters 210b and 212b are connected to the inputs of a second optical switch 232, which performs optical switching operations for optical signals at wavelength λ₂.

In the output portion of the optical wavelength switching system as shown in FIG. 2, a plurality of first-stage combiners 234a and 236a and second-stage combiners 234b and 236b are provided between the optical switches 222 and 232 and the output optical fibers 206 and 208. The first and second-stage combiners combine switched optical signals at wavelengths λ₁ and λ₂ with the optical signals at wavelengths λ₃ and λ₄ together to form wavelength-multiplexed output optical signals, which are transmitted along the output optical fibers 206 and 208. The second-stage combiner 234b has a first input connected to one of the outputs of the second optical switch 232 to receive switched single-channel optical signals at wavelength λ₂ and a second input connected to the band-reject output 226 of the second-stage splitter 210b for receiving optical signals in the remaining wavelength channels at wavelengths λ₃ and λ₄. In an embodiment, an optical fiber 240 is connected directly between the band-reject output 226 of the splitter 210b and the second input of the combiner 234b.

The output of the second-stage combiner 234btransmits wavelength-multiplexed optical signals at wavelengths λ₂,λ₃ and λ₄. The first-stage combiner 234a, which is connected to the output optical fiber 206, has a first input connected to one of the outputs of the first optical switch 222 for receiving single-channel optical signals at wavelength λ₁ and a second input connected to the output of the second-stage combiner 234b for receiving wavelength-multiplexed optical signals at wavelengths λ₂, λ₃ and λ₄. The first-stage combiner 234a combines the optical signals from the first optical switch 222 at wavelength λ₁ and the optical signals at wavelengths λ₂, λ₃ and λ₄ from the second-stage combiner 234b to form a wavelength-multiplexed output optical signal at wavelengths λ₁, λ₂, λ₃ and λ₄ for transmission along the output optical fiber 206.

In a similar manner, the second-stage combiner 236b has a first input which is connected to one of the outputs of the second optical switch 232 for receiving optical signals at wavelength λ₂ and a second input which is connected to the band-reject output 230 of the second-stage splitter 212b for receiving optical signals in the remaining wavelength channels at wavelengths λ₃ and λ₄. In an embodiment, an optical fiber 242 is connected directly between the band-reject output 230 of the splitter 212b and the second input of the combiner 236b. The output of the second-stage combiner 236b is capable of transmitting wavelength-multiplexed optical signals at wavelengths λ₂, λ₃ and λ₄.

The first-stage combiner 236a, which is connected to the output optical fiber 208, has a first input connected to one of the outputs of the first optical switch 222 for receiving switched single-channel optical signals at wavelength λ₁, and a second input which is connected to the output of the second-stage combiner 236b for receiving wavelength-multiplexed optical signals at wavelengths λ₂, λ₃ and λ₄. The first-stage combiner 236a combines the input optical signals together to form a wavelength-multiplexed output optical signal at wavelengths λ₁, λ₂, λ₃ and λ₄ for transmission along the output optical fiber 208.

More than four wavelength channels may be carried by each of the input and output optical fibers 202, 204, 206 and 208 in the optical wavelength switching system as shown in FIG. 2. The optical wavelength switching system in this embodiment may be implemented to switch up to two of the wavelength channels carried by each of the input optical fibers selected for optical switching. In an embodiment, the splitters 210a, 210b, and 212a and 212b and the combiners 234a, 234b, 236a and 236b are tunable wavelength channel splitters and combiners, respectively, with passbands tunable over the range of wavelengths carried by the optical fibers.

In an embodiment, each of the first-stage and second-stage splitters comprises a tunable optical filter having an input, a band-pass output and band-reject output. The first-stage and second-stage combiners as shown in FIG. 2 may be regarded as the symmetric inverse, or a mirror image, of the first-stage and second-stage splitters, respectively. The passbands of the combiners in the output portion of the optical wavelength switching system are respectively tuned to the same passbands of corresponding splitters in the input portion of the optical wavelength switching system. For example, if the passbands of the first-stage tunable wavelength channel splitters 210a and 210a are tuned to wavelength λ₁, then the first-stage combiners 234a and 236a also have their first inputs tuned to receive optical signals at wavelength λ₁. In a similar manner, if the passbands of the second-stage splitters 210b and 212b are tuned to wavelength λ₂, then the first inputs of the second-stage combiners are also tuned to receive optical signals at wavelength λ₂. For each of the tunable wavelength channel combiners, the first input may be regarded as the band-pass input and the second input may be regarded as the band-reject input capable of receiving optical signals outside the tunable passband of the combiner. In an embodiment, the first-stage and second-stage splitters and the first-stage and second-stage combiners can be tuned to any two of the wavelengths selected from a large number of optical wavelengths in a dense wavelength division multiplexing (DWDM) network.

The wavelengths λ₁, and λ₂ are variable wavelengths instead of fixed wavelengths in an embodiment in which the splitters and the combiners can be dynamically tuned to any two of the wavelengths selected for switching by the optical switches 222 and 232. Furthermore, additional wavelengths may be carried by the input and output optical fibers through the optical wavelength switching system as shown in FIG. 2. For example, optical signals at wavelengths λ₃ and λ₄ as well as other optical wavelengths which need not be switched by the optical switches 222 and 232 in the optical wavelength switching system as shown in FIG. 2 may pass through the optical fibers 240 and 242 connected between the splitter 210b and the combiner 234b and between the splitter 212b and the combiner 236b, respectively, to the output optical fibers 206 and 208.

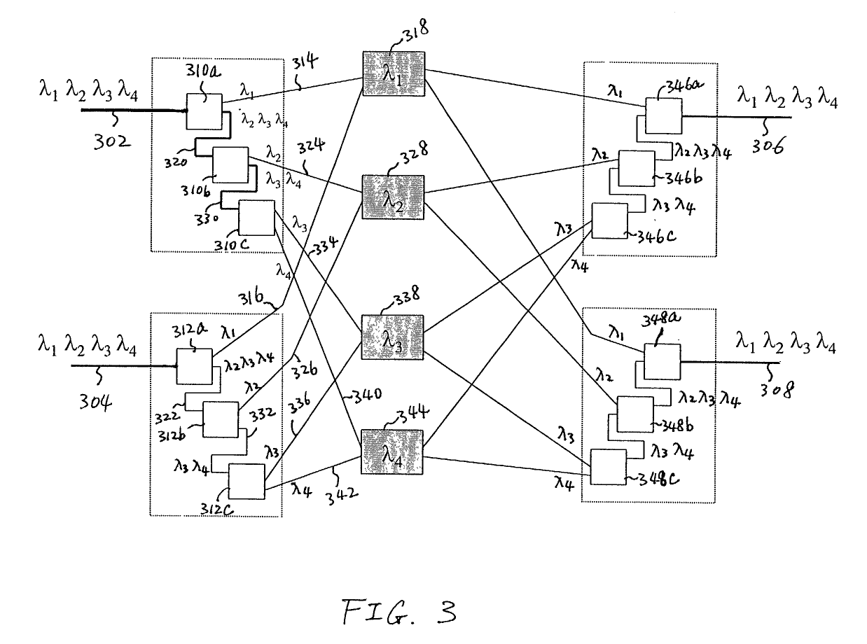

FIG. 3 shows an embodiment of an optical wavelength switching system according to the present invention, with four optical switches and three stages of wavelength selective splitters and combiners for switching optical signals in four wavelength channels among different input and output optical fibers in a DWDM network. In FIG. 3, the input optical fibers 302 and 304 and the output optical fibers 306 and 308 each carry optical signals in four wavelength-multiplexed optical channels. In the input portion of the optical wavelength switching system, first-stage wavelength selective splitters 310a and 312a have inputs connected to the input optical fibers 302 and 304, respectively. The first-stage splitters 310a and 312a have respective band-pass outputs 314 and 316, both of which are connected to the inputs of the first optical switch 318 that is assigned to switch single-channel optical signals at wavelength λ₁, and respective band-reject outputs 320 and 322 for outputting optical signals at remaining wavelengths λ₂, λ₃ and λ₄.

In an embodiment, the band-reject outputs 320 and 322 of the first-stage splitters 310a and 312a are connected to the inputs of second-stage wavelength selective splitters 310b and 312b, respectively. The second-stage splitters 310b and 312b have respective band-pass outputs 324 and 326, both of which are connected to the inputs of a second optical switch 328 that is assigned to switch optical signals at wavelength λ₂. Furthermore, the second-stage splitters 310b and 312b have respective band-reject outputs 330 and 332 for outputting optical signals at wavelengths λ₃ and λ₄.

In an embodiment, the band-reject outputs 330 and 332 of the second-stage splitters 310b and 312b are connected to the inputs of third-stage splitters 310c and 312c, which have respective band-pass outputs 334 and 336 connected to the inputs of a third optical switch 338 that is assigned to switch optical signals at wavelength λ₃. In a further embodiment, the third-stage splitters 310c and 312c have band-reject outputs 340 and 342, which are connected to the inputs of a fourth optical switch 344 for switching optical signals at wavelength λ₄.

In an embodiment, each of the first, second and third-stage splitters comprises a tunable optical filter with a band-pass output and a band-reject output. The tunable optical filters each have a tunable passband that can be tuned to transmit single-channel optical signals at any of the wavelengths selected for the band-pass output. In this sense, therefore, the wavelengths λ₁, λ₂, λ₃ and λ₄ are variables which can be selected from any of the wavelengths carried by the input optical fibers instead of fixed wavelengths, as long as the wavelengths λ₁, λ₂, λ₃ and λ₄ are distinct from each other. Additional stages of wavelength selective splitters and additional optical switches may be provided in the optical wavelength switching system for wavelength selection and optical cross-connecting or switching of additional optical channels.

In the output portion of the optical wavelength switching system as shown in FIG. 3, a plurality of first-stage combiners 346a and 348a, second-stage combiners 346b and 348b, and third-stage combiners 346c and 348c are provided between the outputs of the optical switches 318, 328, 338 and 344 and the output optical fibers 306 and 308. In an embodiment, the first, second and third-stage combiners are simply a mirror image of the first, second and third-stage splitters in the input portion of the optical wavelength switching system, respectively. As shown in FIG. 3, the third-stage combiners 346c and 348c each have first and second inputs connected to the outputs of the third and fourth optical switches 338 and 344, respectively, for receiving switched optical signals at wavelengths λ₃ and λ₄.

The optical signals at wavelengths λ₃ and λ₄ are combined by respective combiners 346c and 348c to generate wavelength-multiplexed optical signals at wavelengths λ₃ and λ₄. The second-stage combiners 346b and 348b each have a first input connected to receive switched optical signals at wavelength λ₂ from a respective output of the second optical switch 328, and a second input connected to the output of a respective one of the third optical switches 346c and 348c for receiving wavelength-multiplexed optical signals at wavelengths λ₃ and λ₄.

The second-stage combiners 346b and 348b combine respective input signals together to form wavelength-multiplexed optical signals covering the wavelengths λ₂, λ₃ and λ₄ and transmit these signals from respective outputs of the second-stage combiners. The first-stage combiners 346a and 348a have respective first inputs connected to receive single-channel optical signals at wavelength λ₁, from respective outputs of the first optical switch 318, and respective second inputs connected to receive wavelength-multiplexed optical signals at wavelengths λ₂, λ₃ and λ₄ from respective outputs of the second-stage combiners 346b and 348b. The first-stage combiners 346a and 348a combine respective input optical signals together to form wavelength-multiplexed output optical signals at wavelengths λ₁,λ₂, λ₃ and λ₄ to be transmitted along output optical fibers 306 and 308, respectively.

In an embodiment, the combiners in each stage of wavelength combination comprise tunable optical filters with band-pass inputs tuned to a selected wavelength which is identical to the wavelength selected for the band-pass output of the corresponding stage of wavelength selective splitters. For example, if the first-stage splitters 310a and 312a have their passbands tuned to wavelength λ₁, then the first-stage combiners 346a and 348a also have their band-pass inputs, which are connected to the first optical switch 318, tuned to receive switched optical signals at wavelength λ₁. Similarly, if the second-stage splitters 310b and 312b are tuned to transmit optical signals at wavelength λ₂to the second optical switch 328, then the second-stage combiners 346b and 348b also have their band-pass inputs tuned to receive switched optical signals at wavelength λ₂. Furthermore, the third-stage combiners 346c and 348c and the third-stage splitters 310c and 312c have their passbands tuned to an identical wavelength, which in the embodiment shown in FIG. 3, is wavelength λ₃.

As shown in FIG. 3, the band-reject outputs 340 and 342 of the third-stage splitters 310c and 312c are connected to the fourth optical switch 344, which outputs switched optical signals at wavelength λ₄ to respective inputs of the third-stage combiners 346c and 348c. Alternatively, the optical signals at the remaining wavelength λ₄ may be transmitted directly from the band-reject outputs of the third-stage splitters to respective inputs of the third-stage combiners through optical fibers without optical switching, in a similar manner to that which is shown in FIG. 2 and described above. Furthermore, additional wavelengths may be carried directly from the band-reject outputs of the third-stage splitters to respective inputs of the third-stage combiners without optical switching if no more than three wavelengths need be selected at a given time from all of the wavelengths carried by the DWDM network for the optical wavelength switching system to perform optical switching operations. Additional stages of wavelength selective splitters and combiners can also be implemented in cascaded configurations similar to the embodiments described above with reference to FIGS. 2 and 3.

The present invention has been described with respect to particular embodiments thereof, and numerous modifications can be made which are within the scope of the invention as set forth in the claims.

What is claimed is:

1. An optical wavelength switching system, comprising:
a plurality of optical inputs each capable of receiving optical signals in a plurality of optical wavelength channels;
a plurality of splitters comprising a plurality of first-stage splitters connected to the optical inputs, the first-stage splitters each having a band-pass output to transmit optical signals in a first one of the wavelength channels and a band-reject output to transmit optical signals in at least one remaining wavelength channel;
a plurality of optical outputs each capable of transmitting wavelength-multiplexed optical signals;
a plurality of combiners comprising a plurality of first-stage combiners connected to the optical outputs, the first-stage combiners each having a first input to receive optical signals in the first wavelength channel and a second input to receive optical signals in said at least one remaining wavelength channel; and
at least a first optical switch connected between at least one of the splitters and at least one of the combiners to switch optical signals in at least one of the wavelength channels.

2. The system of claim 1, wherein the splitters further comprise a plurality of second-stage splitters each having an input connected to the band-reject output of a respective one of the first-stage splitters.

3. The system of claim 2, wherein the second-stage splitters each have a band-pass output and a band-reject output, the band-pass output of each of the second-stage splitters connected to transmit optical signals in a second one of the wavelength channels.

4. The system of claim 3, wherein the combiners further comprise a plurality of second-stage combiners each having a first input and a second input, the first input of each of the second-stage combiners connected to receive optical signals in the second wavelength channel.

5. The system of claim 4, wherein the second-stage combiners each have an output connected to the second input of a respective one of the first-stage combiners.

6. The system of claim 4, further comprising a second optical switch connected between the second-stage splitters and the second-stage combiners.

7. The system of claim 6, wherein the splitters further comprise a plurality of third-stage splitters each having an input connected to the band-reject output of a respective one of the second-stage splitters, a band-pass output connected to transmit optical signals in a third one of the wavelength channels, and a band-reject output.

8. The system of claim 7, wherein the combiners further comprise a plurality of third-stage combiners each having a first input and a second input, the first input of each of the third-stage combiners connected to receive optical signals in the third wavelength channel.

9. The system of claim 8, further comprising a third optical switch connected between the third-stage splitters and the third-stage combiners.

10. The system of claim 9, further comprising a fourth optical switch connected between the band-reject outputs of the third-stage splitters and the second inputs of the third-stage combiners.

11. An optical wavelength switching system, comprising:
a plurality of optical inputs each capable of receiving optical signals in a plurality of optical wavelength channels;
a plurality of tunable wavelength channel splitters comprising a plurality of first-stage splitters connected to the optical inputs, the first-stage splitters each having a band-pass output to transmit optical signals in a first one of the wavelength channels and a band-reject output to transmit optical signals in at least one remaining wavelength channel;
a plurality of optical outputs each capable of transmitting wavelength-multiplexed optical signals;
a plurality of tunable wavelength channel combiners comprising a plurality of first-stage combiners connected to the optical outputs, the first-stage combiners each having a first input to receive optical signals in the first wavelength channel and a second input to receive optical signals in said at least one remaining wavelength channel; and
a plurality of optical switches connected between the splitters and the combiners to switch optical signals in at least some of the wavelength channels.

12. The system of claim 11, wherein the tunable wavelength channel splitters further comprise a plurality of second-stage splitters each having an input connected to the band-reject output of a respective one of the first-stage splitters.

13. The system of claim 12, wherein the second-stage splitters each have a band-pass output and a band-reject output, the band-pass output of each of the second-stage splitters connected to transmit optical signals in a second one of the wavelength channels.

14. The system of claim 13, wherein the tunable wavelength channel combiners further comprise a plurality of second-stage combiners each having a first input and a second input, the first input of each of the second-stage combiners connected to receive optical signals in the second wavelength channel.

15. The system of claim 14, wherein the optical switches comprise a first optical switch connected between the first-stage splitters and the first-stage combiners.

16. The system of claim 15, wherein the optical switches further comprise a second optical switch connected between the second-stage splitters and the second-stage combiners.

17. The system of claim 16, wherein the tunable wavelength channel splitters further comprise a plurality of third-stage splitters each having an input connected to the band-reject output of a respective one of the second-stage splitters.

18. The system of claim 17, wherein the third-stage splitters each have a band-pass output and a band-reject output, the band-pass output of each of the third-stage splitters connected to transmit optical signals in a third one of the wavelength channels.

19. The system of claim 18, wherein the tunable wavelength channel combiners further comprise a plurality of third-stage combiners each having a first input and a second input, the first input of each of the third-stage combiners connected to receive optical signals in the third wavelength channel.

20. The system of claim 19, wherein the optical switches further comprise a third optical switch connected between the third-stage splitters and the third-stage combiners.

21. The system of claim 20, wherein the optical switches further comprise a fourth optical switch connected between the band-reject outputs of the third-stage splitters and the second inputs of the third-stage combiners.

22. An optical wavelength switching system, comprising:
a plurality of tunable wavelength channel splitters, comprising:
a plurality of first-stage splitters each having an input to receive optical signals in a plurality of optical wavelength channels, a band-pass output to transmit optical signals in a first one of the wavelength channels, and a band-reject output; and
a plurality of second-stage splitters each having an input connected to the band-reject output of a respective one of the first-stage splitters, a band-pass output to transmit optical signals in a second one of the wavelength channels, and a band-reject output;
a plurality of tunable wavelength channel combiners, comprising:
a plurality of first-stage combiners each having a first input to receive optical signals in the first wavelength channel, a second input, and an output to transmit wavelength-multiplexed optical signals; and
a plurality of second-stage combiners each having a first input to receive optical signals in the second wavelength channel, a second input, and an output connected to the second input of a respective one of the first-stage combiners;
a first optical switch connected between the first-stage splitters and the first-stage combiners to switch optical signals in the first wavelength channel; and
a second optical switch connected between the second-stage splitters and the second-stage combiners to switch optical signals in the second wavelength channel.

23. The system of claim 22, wherein the band-reject output of each of the second-stage splitters is connected to the second input of a respective one of the second-stage combiners.

24. The system of claim 22, wherein the first optical switch is connected between the band-pass outputs of the first-stage splitters and the first inputs of the first-stage combiners.

25. The system of claim 24, wherein the second optical switch is connected between the band-pass outputs of the second-stage splitters and the first inputs of the second-stage combiners.

26. The system of claim 25, wherein the tunable wavelength channel splitters further comprise a plurality of third-stage splitters each having an input connected to the band-reject output of a respective one of the second-stage splitters.

27. The system of claim 26, wherein the third-stage splitters each have a band-pass output and a band-reject output, the band-pass output of each of the third-stage splitters connected to transmit optical signals in a third one of the wavelength channels.

28. The system of claim 27, wherein the tunable wavelength channel combiners further comprise a plurality of third-stage combiners each having a first input and a second input, the first input of each of the third-stage combiners connected to receive optical signals in the third wavelength channel.

29. The system of claim 28, wherein the third-stage combiners each have an output connected to the second input of a respective one of the second-stage combiners.

30. The system of claim 29, further comprising a third optical switch connected between the band-pass outputs of the third-stage splitters and the first inputs of the third-stage combiners.

31. The system of claim 30, further comprising a fourth optical switch connected between the band-reject outputs of the third-stage splitters and the second inputs of the third-stage combiners.

32. The system of claim 22, wherein the first-stage splitters and the first-stage combiners are tunable to any one of the wavelength channels designated as the first wavelength channel selected for switching by the first optical switch.

33. The system of claim 32, wherein the second-stage splitters and the second-stage combiners are tunable to any one of the wavelength channels other than the first wavelength channel designated as the second wavelength channel selected for switching by the second optical switch.
